(19) United States
(12) Patent Application Publication
(10) Pub. No.: US 2025/0044665 A1
(43) Pub. Date: Feb. 6, 2025

(54) APERTURE STRUCTURE, LENS ASSEMBLY AND TERMINAL

(71) Applicant: BEIJING XIAOMI MOBILE SOFTWARE CO., LTD., Beijing (CN)

(72) Inventors: Hui WANG, Beijing (CN); Bin WANG, Beijing (CN)

(21) Appl. No.: 18/604,040

(22) Filed: Mar. 13, 2024

(30) Foreign Application Priority Data
Jul. 31, 2023 (CN) 202310955328.8

(51) Int. Cl. G03B 9/06; G03B 30/00

(52) U.S. Cl. CPC G03B 9/06; G03B 30/00

(57) ABSTRACT

An aperture structure includes a substrate, a blade and a shielding assembly. The blade has a light transmitting hole. The shielding assembly and the light transmitting hole form a first aperture hole having a polygonal shape. At least one of the blade or the shielding assembly is movably arranged on the substrate in a first direction, to change the size of the first aperture hole.

### CROSS-REFERENCE TO RELATED APPLICATIONS

The present application claims the benefit of priority to Chinese Application No. 202310955328.8, filed on Jul. 31, 2023, the contents of which are incorporated herein by reference in their entireties for all purposes.

### BACKGROUND

At present, many cameras use variable apertures to adjust the amount of light entering a lens, which may allow users to take more suitable photos in a variety of different lighting conditions. The main visual impact on an image that is caused by the change in a size of an aperture is the change in depth of field.

### SUMMARY

The present disclosure relates to the field of apertures, and more particularly to an aperture structure, a lens assembly and a terminal.

According to a first aspect of the present disclosure, an aperture structure is provided, including a substrate, a blade and a shielding assembly. The blade has a light transmitting hole. The shielding assembly and the light transmitting hole form a first aperture hole having a polygonal shape. At least one of the blade or the shielding assembly is movably arranged on the substrate in a first direction, to change a size of the first aperture hole.

According to a second aspect of the present disclosure, a lens assembly is provided, including an aperture structure as described above.

According to a third aspect of the present disclosure, a terminal is provided, including a lens assembly as described above.

### BRIEF DESCRIPTION OF THE DRAWINGS

The drawings are intended to provide a further understanding of the present disclosure, form a part of the specification, and are used to explain the present disclosure together with the specific embodiments below, but do not constitute a limitation of the present disclosure, in which:

FIG. 1 is a schematic perspective view of an aperture structure according to a first embodiment of the present disclosure;

FIG. 2 is an exploded view of an aperture structure according to a first embodiment of the present disclosure;

FIG. 3 is a schematic view of an aperture structure in a first state according to a first embodiment of the present disclosure;

FIG. 4 is a schematic view of an aperture structure in a second state according to a first embodiment of the present disclosure;

FIG. 5 is a schematic view of an aperture structure in a third state according to a first embodiment of the present disclosure;

FIG. 6 is a structural schematic view of an aperture structure according to a second embodiment of the present disclosure;

FIG. 7 is a structural schematic view of an aperture structure according to a third embodiment of the present disclosure.

### DETAILED DESCRIPTION

Embodiments of the present disclosure are described in detail below in conjunction with the drawings. It should be understood that the specific embodiments described herein are intended to explain the present disclosure, but not to limit the present disclosure.

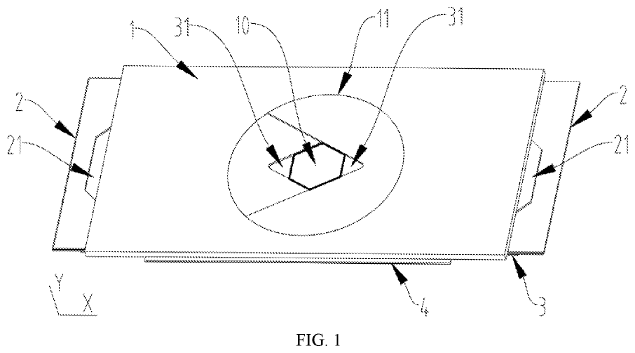

In the present disclosure, unless otherwise expressly defined, terms of orientation such as “the first direction” and “the second direction” used may refer to the XY coordinate system in FIG. 1. Specifically, the X direction refers to the first direction, and the Y direction refers to the second direction. “Inner” and “outer” refer to inner and outer of a contour of each component. Terms such as “first” and “second” used are intended to distinguish one element from another and are not sequential or important. In addition, in the following description, when referring to the drawings, the same references sign in different drawings indicates the same or similar element, which is not repeated in the present disclosure.

In the related art, the current variable apertures are generally adjusted by a group of blades. Specifically, a plurality of blades in the group of blades rotates and fits to change the size of the aperture. However, the blades are prone to getting stuck when rotating, which affects the user experience.

According to embodiments of the present disclosure, an aperture structure is provided. As illustrated in FIGS. 1 to 4 and FIGS. 6 and 7, the aperture structure includes a substrate 1, a blade 2 and a shielding assembly 3. The blade 2 has a light transmitting hole 21. The shielding assembly 3 and the light transmitting hole 21 form a first aperture hole 10 having a polygonal shape. The blade 2 and/or the shielding assembly 3 are movably arranged on the substrate 1 in a first direction, to change a size of the first aperture hole 10.

Through the above technical solution, in the aperture structure provided by the present disclosure, when the shielding assembly 3 moves in the first direction, the relative position between the shielding assembly 3 and the light transmitting hole 21 will change, thus the shielding amount and the shielding position of the shielding assembly 3 on the light transmitting hole 21 will change, therefore, the size of the first aperture hole 10 may be changed. In the same way, when the blade 2 moves in the first direction, or when the blade 2 and the shielding assembly 3 both move in the first direction, the shielding amount and the shielding position of the shielding assembly 3 on the light transmitting hole 21 will also change, thus, the size of the first aperture hole 10 may also be changed. Here, compared to the related art of adjusting the size of the aperture by rotation of the blades, the size of the first aperture hole 10 may be adjusted by linear motion of the blade 2 in the present disclosure, and the blade 2 basically will not get stuck during the linear motion. Furthermore, when the shielding assembly 3 moves and the blade 2 remains stationary, the blade 2 also will not get stuck, so the aperture structure of the present disclosure may solve the technical problem that the blades 2 are prone to getting stuck.

In addition, since the shielding assembly 3 and/or the blade 2 adjust the size of the first aperture hole 10 by means of linear motion, it is conducive to achieving stepless adjustment of the size of the first aperture hole 10. Moreover, the first aperture hole 10 is configured as a polygonal shape, which may also facilitate stepless adjustment of the size of the first aperture hole 10 when the shielding assembly 3 and/or the blade 2 move in the first direction.

It should be noted that the first aperture hole 10 having the “polygonal shape” in the present disclosure may be understood as the first aperture hole having at least three edges. For example, the first aperture hole 10 may have a triangular shape, a quadrilateral shape, etc. In addition, the specific structure of the shielding assembly 3 is not limited in the present disclosure, which will be described in detail in the following embodiments of the present disclosure. Moreover, the present disclosure does not limit the specific structure of a driving structure that drives the shielding assembly 3 or the blade 2 to move. For example, the driving structure may include a linear motor that may drive the shielding assembly 3 or drive the blade 2 to move in the first direction. The driving structure may also include an electromagnetic driving assembly. The electromagnetic driving assembly may include a first electromagnetic member and a second electromagnetic member, one of the first electromagnetic member and the second electromagnetic member is arranged on the substrate 1, the other is arranged on the shielding assembly 3 or the blade 2, and the first electromagnetic member and the second electromagnetic member are spaced apart in the first direction. When the first electromagnetic member and the second electromagnetic member are energized, there may be an attractive force that may attract each other or a repulsive force that may repel each other between the first electromagnetic member and the second electromagnetic member. Therefore, the movement of the shielding assembly 3 or the blade 2 in the first direction may also be achieved by the electromagnetic driving assembly.

In the embodiments of the present disclosure, as illustrated in FIGS. 1 to 4 and FIG. 6 and FIG. 7, the blade 2 and the shielding assembly 3 are movably arranged on the substrate 1 in the first direction. In this way, when the blade 2 and the shielding assembly 3 both move in the first direction, the change of the relative position between the light transmitting hole 21 and the shielding assembly 3 may achieve the adjustment of the size of the first aperture hole 10, and at the same time, it is conducive to keeping a central axis of the first aperture hole 10 stationary relative to the substrate, that is, it is conducive to keeping the position of the central axis of the first aperture hole 10 unchanged. For example, when the size of the first aperture hole 10 changes from a first value to a second value, the central axis of the first aperture hole 10 remains in a same position.

In the embodiments of the present disclosure, as illustrated in FIGS. 1 to 4, the number of blades 2 may be at least two, the at least two blades 2 are stacked together with the shielding assembly 3 in a second direction perpendicular to the first direction, and the shielding assembly 3 and at least two light transmitting holes 21 may cooperatively form the first aperture hole 10 having the polygonal shape. In this way, by arranging the at least two blades 2, the number of light transmitting holes 21 may be increased. Therefore, through the cooperation of the shielding assembly 3 and the at least two light transmitting holes 21, it is conducive to enriching the change in the shape of the first aperture hole 10, that is, it is conducive to configuring the first aperture hole 10 as a plurality of types of polygonal holes, thereby improving the adaptability of the aperture structure.

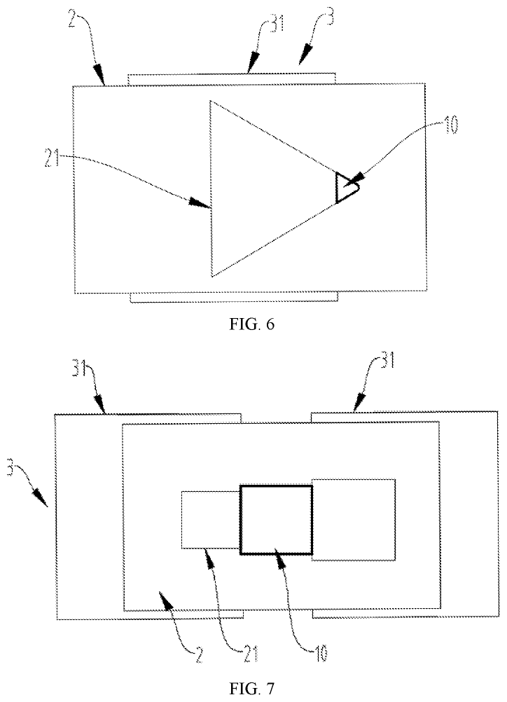

In other embodiments of the present disclosure, as illustrated in FIG. 6, in the embodiment that the number of blades 2 is one, the shielding assembly 3 may include a baffle plate 31, and the light transmitting hole 21 may be configured as a triangular hole. At this time, the first aperture hole 10 may be configured as a triangular hole. When the blade 2 and the baffle plate 31 both move in the first direction, it may achieve that the central axis of the first aperture hole 10 remains stationary relative to the substrate 1 while the size of the first aperture hole 10 is adjusted. Here, according to some embodiments, the light transmitting hole 21 may be configured as an equilateral triangular hole. In this way, when the central axis of the first aperture hole 10 is stationary relative to the substrate 1, it may also be ensured that the first aperture hole itself is the equilateral triangular hole when the size of the first aperture hole 10 changes.

In other embodiments of the present disclosure, as illustrated in FIG. 7, in the embodiment that the number of blades 2 is one, the shielding assembly 3 may include two baffle plates 31, each of the baffle plates 31 is movably arranged on the substrate 1, the light transmitting hole 21 may be configured to have at least two square sub holes arranged in the first direction and communicated in sequence, and the sizes of any two of the square sub holes are not the same. At this time, the first aperture hole 10 may be configured as a square hole. When the blade 2 and the two baffle plates 31 all move along the first direction, the two baffle plates 31 may be fitted with different square sub holes, thus, the adjustment of the size of the first aperture hole 10 may also be achieved. Here, when the blade 2 and the two baffle plates 31 all move in the first direction, the central axis of the first aperture hole 10 may also be stationary relative to the substrate 1.

In some embodiments of the present disclosure, in the embodiment that the blade 2 and the shielding assembly 3 are movably arranged on the substrate 1 in the first direction and the number of the blades 2 is at least two, as illustrated in FIGS. 1 to 4, the number of blades 2 may be two, and the shielding assembly 3 and the two light transmitting holes 21 may cooperatively form the first aperture hole 10 having a regular hexagonal shape. Here, it is well known to those skilled in the art that the closer the aperture is to the circle, the softer the out of focus effect of photographs taken by a lens assembly. Therefore, compared to the first aperture hole 10 that has the triangular shape, the square shape, or a pentagonal shape, the present disclosure designs the first aperture hole 10 as a regular hexagonal hole, which may make the out of focus effect of the photographs taken by the lens assembly with the first aperture hole 10 having the regular hexagonal shape softer. Moreover, the number of blades 2 is two, and the aperture structure is designed thinner in the second direction while ensuring the soft out of focus effect, thus facilitating arrangement of the aperture structure in a structure with narrow installation space, such as in the lens assembly. In other embodiments, in the embodiment that the blade 2 and the shielding assembly 3 are movably arranged on the substrate 1 in the first direction and the number of the blades 2 is a plurality, the shielding assembly 3 and the plurality of light transmitting holes 21 may cooperatively form the first aperture hole 10 having a regular polygonal shape with more than six edges, so that the out of focus effect of the photographs is softer.

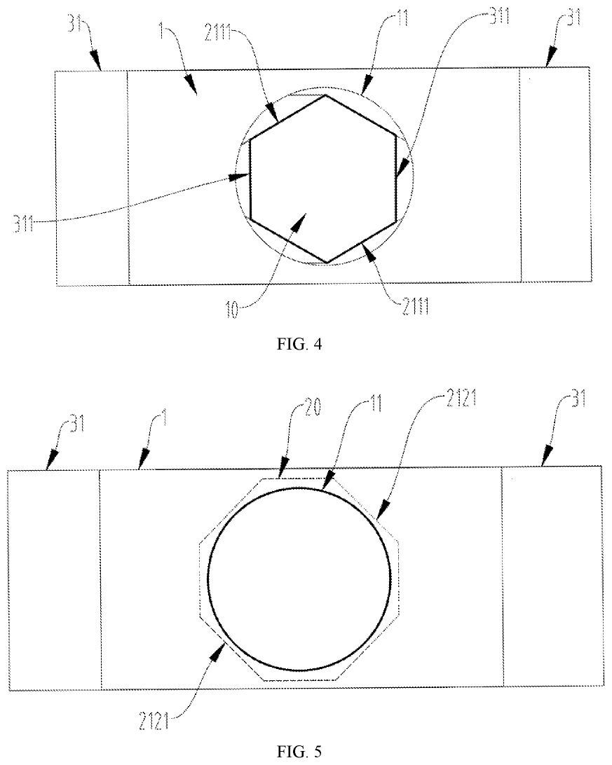

In the embodiment that the first aperture hole 10 is a regular hexagonal hole, as illustrated in FIGS. 1 to 4, the shielding assembly 3 may include two baffle plates 31, each of the baffle plates 31 is movably arranged on the substrate 1 in the first direction, and each of the baffle plate 31 has a straight edge 311. In this way, the two baffle plates 31 may move towards each other or move away from each other in the first direction, which achieves that two straight edges 311 move away from each other or move towards each other in the first direction. The light transmitting hole 21 may have a first sub hole 211 having a triangular shape, two first edges 2111 of the first sub hole 211 form an vertex angle 2112, and a center line of the first sub hole 211 at the vertex angle 2112 extends along the first direction. When the blades 2 move, two first edges 2111 of two first sub holes 211 at a same side may be crossed, and the two straight edges 311 of the two baffle plates 31 and the two first sub holes 211 cooperatively form the first aperture hole 10. Here, as illustrated in FIG. 3, the size of the first aperture hole 10 is smaller; and as illustrated in FIG. 4, the size of the first aperture hole 10 is larger. Moreover, as illustrated in FIGS. 3 and 4, when the two first edges 2111 of the two first sub holes 211 at the same side are crossed, and when two vertex angles 2112 move away from each other and the two baffle plates 31 move away from each other, the size of the first aperture hole 10 may be increased. When the two vertex angles 2112 approach each other and the two baffle plates 31 approach each other, the size of the first aperture hole 10 may be reduced. Therefore, when the two baffle plates 31 and the two blades 2 move in the first direction, the stepless adjustment of the size of the first aperture hole 10 may be achieved. In addition, when the two baffle plates 31 and the two blades 2 move simultaneously, continuous adjustment of the size of the first aperture hole 10 may be achieved. Therefore, a wide range of adjustment of the size of the first aperture hole 10 may be realized while the baffle plate 31 and the blades 2 have a small movement distance. In this way, the aperture structure in the present disclosure may be designed to be miniaturized and occupy less space when applied to the lens assembly, and the wide range of adjustment of the size of the first aperture hole 10 may enable the lens assembly to be applied to various usage scenarios.

In some embodiments of the present disclosure, as illustrated in FIGS. 1 to 4, the two straight edges 311 of the two baffle plates 31 may be adjacent in the first direction. Therefore, the movement distance of the baffle plate 31 may be shortened, which is conducive to the miniaturization of the aperture structure.

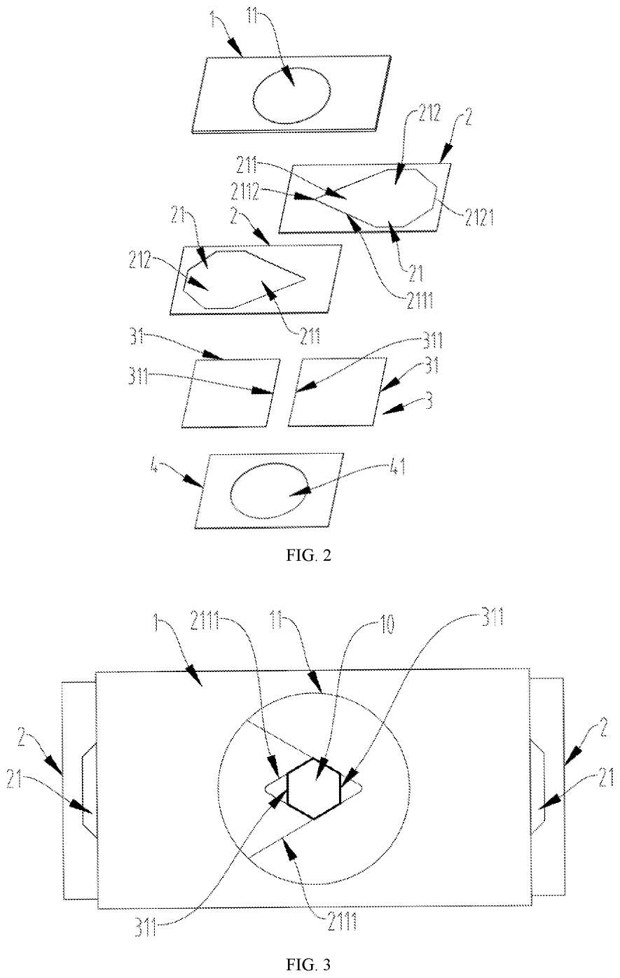

In some embodiments of the present disclosure, as illustrated in FIG. 2, the baffle plate 31 may be configured as a rectangular plate. Therefore, during the assembly of the aperture structure, any one of edges of the baffle plate 31 may be configured as the straight edge 311. Therefore, the baffle plate 31 configured as the rectangular plate is conducive to the installation of the baffle plate 31.

In some embodiments of the present disclosure, as illustrated in FIGS. 1 and 2, thicknesses of the two baffle plates 31 in the second direction may be the same, thus facilitating the two baffle plates 31 to move away from each other or move towards each other.

In some embodiments of the present disclosure, as illustrated in FIGS. 1 and 2, the blades 2 may be arranged between the substrate 1 and the baffle plates 31. In this way, compared to the way of arranging the baffle plates 31 between the two blades 2, the blades 2 arranged between the substrate 1 and the baffle plates 31 is conducive to the smooth movement of each of the blades 2, that is, this design may avoid the baffle plates 31 affecting the smoothness of the movement of the blades 2. The baffle plates 31 may also be arranged between the two blades 2.

In some embodiments of the present disclosure, as illustrated in FIGS. 1, 2 and 5, the substrate 1 may have a through hole 11, and the first aperture hole 10 is arranged such that a projection of the first aperture hole 10 in the second direction is located in the through hole 11, that is, the light transmission area of the first aperture hole 10 is smaller than the light transmission area of the through hole 11, and the first aperture hole 10 transmits light through the through hole 11. In this way, the light transmitting hole 21 may have a second sub hole 212 in communication with the first sub hole 211. When the blades 2 move, two second sub holes 212 may form a hole 20 fully exposing the through hole 11, the hole 20 being referred to also as an avoidance hole 20. When the blades 2 move to a position where a projection of the through hole 11 in the second direction is located in the avoidance hole 20, the through hole 11 may be configured as a second aperture hole. That is, the area of the avoidance hole 20 is greater than the light transmission area of the through hole 11. In this way, when the first aperture hole 10 cannot meet the usage scenarios of the lens assembly, the two blades 2 may be enabled to form the avoidance hole 20, and the two baffle plates 31 may be in a position of avoiding the through hole 11. At this time, the through hole 11 may be configured as the second aperture hole. Herein, the light transmission area of the through hole 11 is greater than the light transmission area of the first aperture hole 10, therefore, configuring the through hole 11 as the second aperture hole may meet the usage scenarios of a large aperture of the lens assembly. In addition, since the second sub hole 212 is in communication with the first sub hole 211, the two blades 2 may quickly form the avoidance hole 20 under a small movement distance, thereby facilitating the miniaturization of the aperture structure. Here, the specific shape of the through hole 11 is not limited in the present disclosure, which thus may be adaptively designed according to the needs in the present disclosure. Therefore, the second aperture hole is configured as different shapes, facilitating the application of the lens assembly in more usage scenarios.

In an embodiment, as illustrated in FIGS. 1 to 5, the through hole 11 may be configured as a circular hole. Therefore, when the through hole 11 is configured as the second aperture hole, the out of focus effect of photographs taken by the lens may be softer. In other embodiments, the through hole 11 may also be configured as an octagonal hole or a hexadecagonal hole, which is not limited in the present disclosure.

In an embodiment, as illustrated in FIGS. 1, 2, and 5, the second sub hole 212 has five second edges 2121 connected in sequence, and when the blades 2 move, the two second sub holes 212 may form the avoidance hole 20 having an octagonal shape. In this way, the avoidance hole 20 having the octagonal shape is conducive to avoiding the through hole 11, so that the through hole 11 is configured as the second aperture hole. In other embodiments, the second sub hole 212 may also be configured as a semicircular hole, and the two second sub holes 212 may form the avoidance hole 20 having a circular shape. Alternatively, two avoidance holes 20 may also be formed in a hexagonal shape or a decagonal shape, which is not limited by the present disclosure.

In other embodiments of the present disclosure, as illustrated in FIGS. 1, 2 and 5, the substrate 1 may have the through hole 11, and the first aperture hole 10 is arranged such that the projection of the first aperture hole in the second direction is located in the through hole 11, that is, the light transmission area of the first aperture hole is smaller than the light transmission area of the through hole, and the first aperture hole transmits light through the through hole. In this way, the light transmitting hole 21 may have the second sub hole 212 in communication with the first sub hole 211. When the blades 2 move, two second sub holes 212 may form the avoidance hole 20, and a shape and size of the avoidance hole 20 are the same as that of the through hole 11. When the blades 2 move to a position where a center axis of the avoidance hole and a center axis of the through hole 11 are collinear, the through hole 11 may be configured as the second aperture hole. In this way, when the first aperture hole 10 cannot meet the usage scenarios of the lens assembly, the two blades 2 may be enabled to form the avoidance hole 20, and the two baffle plates 31 are in a position of avoiding the through hole, at this time, the through hole 11 may be configured as the second aperture hole. Herein, the light transmission area of the through hole 11 is greater than the light transmission area of the first aperture hole 10. Therefore, configuring the through hole 11 as the second aperture hole may meet the usage scenarios of the large aperture of the lens assembly. In addition, since the second sub hole 212 is in communication with the first sub hole 211, the two blades 2 may quickly form the avoidance hole 20 under a small movement distance, thereby facilitating the miniaturization of the aperture structure. Here, the specific shape of the through hole 11 is not limited in the present disclosure, which thus may be adaptively designed according to the needs in the present disclosure. Therefore, the second aperture hole is configured as different shapes, facilitating the application of the lens assembly in more usage scenarios.

In an embodiment, the through hole 11 may be configured as a circular hole, the second sub hole 212 may be configured as a semicircular hole, and the two second sub holes 212 may form a circular avoidance hole 20. Therefore, when the through hole 11 is configured as the second aperture hole, the out of focus effect of photographs taken by the lens may be softer.

In other embodiments of the present disclosure, the substrate 1 may have the through hole 11, and the first aperture hole 10 is arranged such that the projection of the first aperture hole in the second direction is located in the through hole 11, that is, the light transmission area of the first aperture hole 10 is smaller than the light transmission area of the through hole 11, and the first aperture hole 10 transmits light through the through hole 11. In this way, when the blades 2 and the baffle plates 31 move to be staggered with the through hole 11, the through hole 11 may be configured as the second aperture hole. In this way, when the first aperture hole 10 cannot meet the usage scenarios of the lens assembly, the blades 2 and the baffle plates 31 may be in a position of avoiding the through hole 11, at this time, the through hole 11 may be configured as the second aperture hole. Herein, the light transmission area of the through hole 11 is greater than the light transmission area of the first aperture hole 10. Therefore, configuring the through hole 11 as the second aperture hole may meet the usage scenarios of a large aperture of the lens assembly. Here, the specific shape of the through hole 11 is not limited in the present disclosure, which thus may be adaptively designed according to the needs in the present disclosure. Therefore, the second aperture hole is configured as different shapes, facilitating the application of the lens assembly in more usage scenarios.

In addition, as illustrated in FIGS. 1 and 2, the aperture structure may include a base 4, and the base 4 has a light through hole 41 with the same shape as the through hole 11. The size of the light through hole 41 is the same as that of the through hole 11, and the blades 2 and baffle plates 31 may be arranged between the base 4 and the substrate 1, thereby improving the stability of the blades 2 and the baffle plates 31 when moving.

A specific use process of the aperture structure will be described in detail below in the present disclosure in conjunction with the above specific embodiments. First, the base 4, the two baffle plates 31, the two blades 2, and the substrate 1 are sequentially stacked together in the second direction. At this time, as illustrated in FIG. 3, the first aperture hole 10 may be configured as a regular hexagonal hole, and the size of the first aperture hole 10 is smaller. When the size of the first aperture hole 10 needs to be increased, the two vertex angles 2112 of the two blades 2 may be moved away from each other, and the two baffle plates 31 are moved away from each other. At this time, as illustrated in FIG. 4, the size of the first aperture hole 10 is larger. When the size of the first aperture hole 10 needs to be reduced, the two vertex angles 2112 of the two blades 2 may be moved towards each other, and the two baffle plates 31 are moved towards each other. At this time, the size of the first aperture hole 10 may be reduced. When it is necessary to configure a circular through hole 11 as the second aperture hole, two baffle plates 31 may be moved to avoid the through hole 11, and two blades 2 are moved, so that the two second sub holes 212 form an octagonal avoidance hole 20, and the projection of the through hole 11 in the second direction is located in the avoidance hole 20. At this time, as illustrated in FIG. 5, the through hole 11 is configured as the second aperture hole.

According to a second aspect of the present disclosure, a lens assembly is provided, including an aperture structure as described above. This lens assembly has all the beneficial effects of the aperture structure described above, which will not be repeated herein. Here, in the embodiment that the lens assembly has the aperture structure, its own miniaturization design may be achieved, thereby facilitating arranging the lens assembly in a terminal, such as a mobile phone.

According to some embodiments, when the lens assembly is actually used, an appropriate aperture size may be selected according to different shooting purposes and scenes. Generally speaking, when shooting portrait close-ups, details of flowers and plants, and other subjects that need to highlight the subject and background blur, a large aperture may be chosen. When shooting landscapes, architecture, still life, and other subjects that need to maintain a clear panoramic view and a large depth of field, a small aperture may be chosen. When shooting nighttime lighting, starry sky, and other subjects that require a starry effect, a small aperture may be chosen.

According to a third aspect of the present disclosure, a terminal is provided, including a lens assembly as described above. This terminal has all the beneficial effects of the lens assembly described above, which will not be repeated herein. Here, the present disclosure does not limit the specific types of terminals. According to some embodiments, the terminal may be a mobile terminal, such as a mobile phone, a tablet computer, a laptop computer, etc. The terminal may also be a wearable terminal, for example, the wearable terminal may be a wristband, a smart watch, etc. In addition, the terminal may also be an intelligent camera controlled remotely, or be a drone controlled remotely.

According to a first aspect of the present disclosure, an aperture structure is provided, including a substrate, a blade and a shielding assembly. The blade has a light transmitting hole. The shielding assembly and the light transmitting hole form a first aperture hole having a polygonal shape. The blade and/or the shielding assembly are movably arranged on the substrate in a first direction, to change a size of the first aperture hole.

In some embodiments, the blade and the shielding assembly are movably arranged on the substrate in the first direction.

In some embodiments, at least two blades are provided, the at least two blades are stacked together with the shielding assembly in a second direction perpendicular to the first direction, and the shielding assembly and at least two light transmitting holes cooperatively form the first aperture hole having the polygonal shape.

In some embodiments, two blades are provided, and the shielding assembly and the two light transmitting holes cooperatively form the first aperture hole having a regular hexagonal shape.

In some embodiments, the shielding assembly comprises two baffle plates, each of the baffle plates is movably arranged on the substrate in the first direction, and each of the baffle plates has a straight edge; the light transmitting hole has a first sub hole having a triangular shape, two first edges of the first sub hole form a vertex angle, a center line of the first sub hole at the vertex angle extends along the first direction, and when the blades move, two first edges of two first sub holes at a same side are crossed; and two straight edges of the two baffle plates and the two first sub holes cooperatively form the first aperture hole.

In some embodiments, the two straight edges of the two baffle plates are adjacent in the first direction.

In some embodiments, the baffle plate is configured as a rectangular plate.

In some embodiments, the blades are arranged between the substrate and the baffle plates.

In some embodiments, the substrate has a through hole, and the first aperture hole is arranged such that a projection of the first aperture hole in the second direction is located in the through hole; the light transmitting hole has a second sub hole in communication with the first sub hole, and when the blades move, two second sub holes form an avoidance hole; and when the blades move to a position where a projection of the through hole in the second direction is located in the avoidance hole, the through hole is configured as a second aperture hole.

In some embodiments, the through hole is configured as a circular hole.

In some embodiments, the second sub hole has five second edges connected in sequence, and when the blades move, the two second sub holes form the avoidance hole having an octagonal shape.

According to a second aspect of the present disclosure, a lens assembly is provided, including an aperture structure as described above.

According to a third aspect of the present disclosure, a terminal is provided, including a lens assembly as described above.

The preferred embodiment of the present disclosure is described in detail above in conjunction with the drawings, however, the present disclosure is not limited to the specific details in the above embodiment, a variety of simple variants of the technical solution of the present disclosure may be made within the scope of the technical conception of the present disclosure, and these simple variants all fall within the protection scope of the present disclosure.

In addition, it should be noted that the specific technical features described in the specific embodiments, without contradiction, may be combined in any appropriate way, and in order to avoid unnecessary repetition, the various possible combinations are not separately stated in the present disclosure.

In addition, various embodiments of the present disclosure may be arbitrarily combined, and as long as they do not contradict the idea of the present disclosure, they shall also be regarded as the content disclosed in the present disclosure.

What is claimed is:

1. An aperture structure, comprising:
a substrate;
a blade having a light transmitting hole; and
a shielding assembly, the shielding assembly and the light transmitting hole forming a first aperture hole having a polygonal shape,
wherein at least one of the blade or the shielding assembly is movably arranged on the substrate in a first direction, to change a size of the first aperture hole.

2. The aperture structure according to claim 1, wherein the blade and the shielding assembly are movably arranged on the substrate in the first direction.

3. The aperture structure according to claim 1, comprising at least two blades, wherein the at least two blades are stacked together with the shielding assembly in a second direction perpendicular to the first direction, and the shielding assembly and at least two light transmitting holes cooperatively form the first aperture hole having the polygonal shape.

4. The aperture structure according to claim 3, comprising two blades, wherein the shielding assembly and the at least two light transmitting holes cooperatively form the first aperture hole having a regular hexagonal shape.

5. The aperture structure according to claim 4, wherein the shielding assembly comprises two baffle plates, each of the two baffle plates is movably arranged on the substrate in the first direction, and each of the two baffle plates has a straight edge;
each light transmitting hole has a first sub hole having a triangular shape, two first edges of each first sub hole form a vertex angle, and a center line of each first sub hole at the vertex angle extends along the first direction; when the two blades move, two first edges of two first sub holes at a same side are crossed; and
two straight edges of the two baffle plates and the two first sub holes cooperatively form the first aperture hole.

6. The aperture structure according to claim 5, wherein the two straight edges of the two baffle plates are adjacent in the first direction.

7. The aperture structure according to claim 6, wherein the two straight edges of the two baffle plates are movable towards each other or away from each other in the first direction.

8. The aperture structure according to claim 5, wherein each of the two baffle plates is configured as a rectangular plate.

9. The aperture structure according to claim 5, wherein the two blades are arranged between the substrate and the two baffle plates.

10. The aperture structure according to claim 5, wherein the substrate has a through hole, and the first aperture hole is arranged such that a projection of the first aperture hole in the second direction is located in the through hole;
each light transmitting hole has a second sub hole in communication with the first sub hole, and when the two blades move, two second sub holes form an avoidance hole; and
when the two blades moves to a position where a projection of the through hole in the second direction is located in the avoidance hole, the through hole is configured as a second aperture hole.

11. The aperture structure according to claim 10, wherein the through hole is configured as a circular hole.

12. The aperture structure according to claim 10, wherein each second sub hole has five second edges connected in sequence, and when the two blades move, the two second sub holes form the avoidance hole having an octagonal shape.

13. The aperture structure according to claim 5, wherein when two vertex angles move away from each other and the two baffle plates move away from each other, the size of the first aperture hole is increased; and when the two vertex angles approach each other and the two baffle plates approach each other, the size of the first aperture hole is be reduced.

14. The aperture structure according to claim 5, wherein the two baffle plates has a same thickness in the second direction.

15. The aperture structure according to claim 1, wherein at least one of the shielding assembly or the blade adjusts the size of the first aperture hole by means of linear motion.

16. The aperture structure according to claim 1, wherein the light transmitting hole has a triangular shape.

17. The aperture structure according to claim 1, wherein the light transmitting hole is configured to have at least two square sub holes arranged in the first direction and communicated in sequence.

18. The aperture structure according to claim 17, wherein any two of the at least two square sub holes have different sizes.

19. A lens assembly, comprising:
an aperture structure, comprising:
a substrate;
a blade having a light transmitting hole; and
a shielding assembly, the shielding assembly and the light transmitting hole forming a first aperture hole having a polygonal shape,
wherein at least one of the blade or the shielding assembly is movably arranged on the substrate in a first direction, to change a size of the first aperture hole.

20. A terminal, comprising:
a lens assembly, comprising:
an aperture structure, comprising:
a substrate;
a blade having a light transmitting hole; and
a shielding assembly, the shielding assembly and the light transmitting hole forming a first aperture hole having a polygonal shape,
wherein at least one of the blade or the shielding assembly is movably arranged on the substrate in a first direction, to change a size of the first aperture hole.
